(19) United States
(12) Patent Application Publication
(10) Pub. No.: US 2017/0064557 A1
(43) Pub. Date: Mar. 2, 2017

(54) SYSTEM AND METHOD FOR WIRELESS DYNAMIC SPECTRUM ACCESS

(71) Applicants: Ahmed ALSOHAILY, Toronto (CA); Elvino Silveira Medina de SOUSA, Toronto (CA)

(72) Inventors: Ahmed ALSOHAILY, Toronto (CA); Elvino Silveira Medina de SOUSA, Toronto (CA)

(21) Appl. No.: 14/842,364

(22) Filed: Sep. 1, 2015

(51) Int. Cl. H04W 16/14; H04W 16/10; H04W 72/04

(52) U.S. Cl. CPC H04W 16/14; H04W 72/0453; H04W 16/10

(57) ABSTRACT

A structuring and deployment method is provided for a cellular wireless communication system, employing a single or plurality of Radio Access Technologies (RATs). The method consists of: the deployment of a plurality of synchronized system Access Points (APs); broadcasting the Carrier Activity Information (CAI), specifying actively utilized carriers, with the general system information broadcast for all system APs; determining unutilized carriers at system APs with overlapping coverage by tuning in to the CAI broadcast; accessing unutilized carriers at system APs with overlapping coverage; equipping system APs with multi-mode transceiver modules, capable of demodulating and detecting wireless transmission of all employed RATs, to enable the detection of the CAI of all employed RATs in cellular communication systems employing multiple RATs; accessing unutilized carriers assigned to any RAT at system APs with overlapping coverage; determining unutilized carriers at APs deployed by other mobile network operators by tuning in to the CAI broadcast of APs deployed by other mobile network operators; accessing unutilized carriers at system APs deployed by other mobile network operators.

### TECHNICAL FIELD

The following relates generally to wireless communication spectrum access and more specifically to dynamic wireless carrier access.

### BACKGROUND

Cellular communication systems reuse available radio frequency resources to wirelessly connect system users under the constraint of limited availability of wireless radio frequencies. To ensure the reliable operation of cellular communication systems, specific radio frequency bands, referred to as cellular bands, are set aside for wireless cellular communications by spectrum regulatory authorities such as the Federal Communications Commission in the United States of America and Industry Canada in Canada. The term ‘spectrum’ is commonly used to refer to the aggregate set of bands that are assigned to the cellular communication network, also referred to as the cellular communication system, in any given jurisdiction. Another analogous phrase to spectrum is radio frequency resources.

Cellular bands can be contiguous or non-contiguous and are typically divided into sub-bands, which again can be contiguous or non-contiguous, that are licensed to mobile network operators. A mobile network operator thus deploys the network infrastructure (NI) of a cellular communication system upon obtaining a spectrum utilization license, i.e. a license to use a particular cellular band or sub-band. System Access Points (APs), also referred to as base stations or radio units, are the NI elements that wirelessly connect User Equipment (UE) in cellular communication systems. A mobile network operator typically deploys a single or plurality of system APs to connect UE at any specified geographical area and system radio frequency resources are partially or fully reused at different system APs. The required number of system APs to satisfactorily connect system users at any geographical area is determined by the user traffic demand and radio propagation conditions.

Wireless connection of UE to system APs is facilitated by a wireless radio air interface, referred to as the Radio Access Technology (RAT), which utilizes a specific amount of spectrum. Such a RAT specifies the sets of signals, in terms of modulation, coding, multiple access, and all associated protocols required to achieve communication over the electromagnetic wireless transmission medium. RATs are characterized by the required transmission bandwidth, transmission frame duration, frequency reuse factor between APs, user multiple access scheme, modulation and coding configurations along with the transmission and reception protocols.

Due to the limited amount of spectrum available for cellular systems, RATs are designed with the objective of enabling full spectrum reuse at all system APs/RUs while having the highest possible spectral efficiency and lowest carrier bandwidth, with the carrier bandwidth defined as the lowest transmission bandwidth required to deploy a RAT. Cellular systems employing a RAT with a low carrier bandwidth over a large transmission bandwidth employ multiple carriers over the available transmission bandwidth. RATs can define multiple, non-equal carrier bandwidths to accommodate different total transmission bandwidths. Furthermore, RAT carriers can be deployed in contiguous or non-contiguous bands.

System APs continuously broadcast general system information to allow UE to successfully connect to system APs. The general system information includes, but is not limited to, the frequencies and bandwidths of utilized carriers, information required for demodulation and decoding of received signals along with the identification information of the mobile network operator.

To improve service availability and system performance in any geographical area, cellular communication systems increase the system AP density by deploying additional APs within the same geographical area. However, AP densification can substantially increase interference between system APs, thus requiring the introduction of interference mitigation means between system APs with high interference levels in cellular communication systems. System APs with high interference levels are also referred to as APs with overlapping coverage.

While reducing the transmission power of any system AP reduces interference affecting nearby APs, maintaining service continuity sets a limit on the minimum transmission power of system APs. The minimal AP transmission power is dependent on the wireless channel characteristics and proximity of interfering APs and thus varies between system APs. Therefore, cellular systems with high AP density employ different maximal transmission power levels for different system APs.

Interference mitigation between system APs with overlapping coverage is primarily achieved by assigning different of radio frequency resources, i.e. different carriers, to APs with overlapping coverage for all employed RATs. Carrier assignment at system APs with overlapping coverage is typically fixed in spite of the varying and fluctuating nature of user traffic demand, leading to suboptimal spectrum utilization in cellular communication systems with high AP density; since carriers assigned to certain APs may be unutilized at certain times under fixed carrier assignment. To maintain tangible spectrum utilization at all system APs, cellular systems deploying APs with overlapping coverage exploit traffic variations and fluctuations between system APs by employing dynamic carrier assignment and dynamic carrier access using spectrum sensing. In principle, both techniques take advantage of varying traffic demand between system APs to maximize spectrum utilization.

Under dynamic carrier assignment configurations, interfering system APs exchange traffic demand information to enable APs with high traffic demand to access unutilized carriers assigned to other APs. However, a fundamental shortcoming of this approach is that the amount of information exchange between interfering system APs increases with the number of interfering APs. Dynamic carrier assignment is thus restrained by large scale system AP densification; as a significant amount of system resources would be depleted by information exchange between interfering APs rather than being utilized for carrying user traffic.

An alternative approach to dynamic carrier assignment, that avoids requiring information exchange between system APs, is dynamic carrier access using spectrum sensing. Under dynamic carrier access using spectrum sensing, system APs with overlapping coverage continuously sense radio activity within the system radio frequency bands and opportunistically access carriers unutilized by other system APs. However, such an approach requires accurate spectrum sensing capabilities over wide frequency bands to ensure reliable system operation. Such sensing capabilities are difficult to provide at all system APs, thus limiting the feasibility of dynamic carrier access using spectrum sensing in cellular communication systems.

Cellular communication systems would ideally utilize the most spectrally efficient RAT only. However, variations in the capabilities of UE entail the co-deployment of multiple RATs at system APs in cellular communication systems. System APs are typically capable of utilizing a single or plurality of RATs and cellular communication systems employing multiple RATs are referred to as multi-RAT systems. Multi-RAT systems apportion available radio frequency resources between co-deployed RATs and generally assign spectrum bands or sub-bands to each of the employed RATs based on the historical and/or projected traffic demand for each RAT; i.e. RATs with higher traffic demand would typically be assigned more spectrum, and vice versa. Spectrum partitioning between co-deployed RATs is typically fixed and applied at the system level, i.e. all system APs have the same spectrum partitioning between co-deployed RATs and employed RATs are independently operated in multi-RAT systems.

The independent operation of co-deployed RATs further reduces spectrum utilization in multi-RAT systems with dense AP deployment; since different RATs also experience varying and fluctuating traffic demand at different system APs. A similar inefficiency in overall spectrum utilization at any geographical area is attributed to the independent operation of cellular communication systems deployed by different mobile network operators; since APs deployed by different mobile network operators are also subject to varying and fluctuating traffic demand.

### SUMMARY

In one aspect, a method for dynamic assignment of wireless cellular carrier spectrum is provided, the method comprising: establishing a radio access network comprising the deployment of a plurality of access points having an overlapping service area, each access point being configurable to utilize a dynamically allocated spectrum; and configuring each of the access points to: broadcast carrier activity information, the carrier activity information comprising an indication of utilization of carrier spectrum by the respective access point; monitor spectrum utilization for each other access point in the area; determine, for each of the other access points, whether any of the other access points are assigned unutilized spectrum; request from the other access point access to one or more unutilized spectrum; and access any of the one or more unutilized spectrum.

The broadcast of carrier activity information is may be made with a general system information broadcast.

The monitoring, determining and requesting may be made at a predefined period. The predefined period may be a carrier access period.

The configuration of access to spectrum may be pre-set upon radio access network deployment, may be determined using information exchange between self-configuring system access points; or may be determined by a network element or database communicatively coupled to all system access points.

The radio access network may utilize multiple radio access technologies (RATs) and access points comprising multi-mode transceiver modules capable of demodulating and detecting wireless transmission of all employed RATs. Rach access point utilizing a specific RAT may access unutilized wireless carriers assigned to other RATs at other access points.

The access points tune in to the carrier activity information broadcast of access points deployed by other mobile network operators. The access points deployed by a specific mobile network operator may access unutilized carrier spectrum assigned to access points deployed by other mobile network operators.

In another aspect, a system for dynamic assignment of wireless cellular carrier spectrum in a radio access network is provided, the system comprising a plurality of access points deployable in a configuration such that at least two of the access points have an overlapping service area, each access point configurable to utilize a dynamically allocated spectrum by: broadcasting carrier activity information, the carrier activity information comprising an indication of utilization of carrier spectrum by the respective access point; monitoring spectrum utilization for each other access point in the area; determining, for each of the other access points, whether any of the other access points are assigned unutilized spectrum; requesting from the other access point access to one or more unutilized spectrum; and accessing any of the one or more unutilized spectrum.

Each access point may broadcast carrier activity information with a general system information broadcast.

The monitoring, determining and requesting is made at a predefined period. The predefined period may be a carrier access period.

Each of the access points may be pre-configured to access spectrum upon radio access network deployment, self-configuring to exchange information with at least a subset of the other access points to configure access to spectrum, or communicatively coupled to a network element configuring each access point with the access to spectrum.

The radio access network may utilize multiple radio access technologies (RATs) and access points may comprise multi-mode transceiver modules capable of demodulating and detecting wireless transmission of all employed RATs. Each access point utilizing a specific RAT may access unutilized wireless carriers assigned to other RATs at other access points.

The access points may tune in to the carrier activity information broadcast of access points deployed by other mobile network operators.

Access points deployed by a specific mobile network operator may access unutilized carrier spectrum assigned to access points deployed by other mobile network operators.

In another aspect, a system for wireless cellular communication is provided, the system characterised by: utilizing a plurality of wireless carriers; deploying a plurality of synchronised system access points connecting system user equipment; assignment of different wireless carriers to system APs with overlapping coverage; system APs continuously broadcasting information specifying actively utilized wireless carriers with the general system information; system APs with overlapping coverage determining unutilized wireless carriers by tuning in to the carrier activity information broadcast; and system APs with overlapping coverage accessing unutilized wireless carriers assigned to other system APs. The configuration of access of system APs with overlapping coverage to unutilized wireless carriers assigned to other system APs may be pre-set upon AP deployment, determined using information exchange between self-configuring system APs; or determined by a network element/database connecting to all system APs.

The system may utilize multiple radio access technologies and system access points equipped with multi-mode transceiver modules capable of demodulating and detecting wireless transmission of all employed RATs. The system access points utilizing a specific RAT may access unutilized wireless carriers assigned to other RATs at other APs.

The system access points may tune in to the carrier activity information broadcast of access points deployed by other mobile network operators. The system access points deployed by a specific mobile network operator may access unutilized wireless carriers assigned to APs deployed by other mobile network operators.

These and other embodiments are contemplated and described herein. It will be appreciated that the foregoing summary sets out representative aspects of systems and methods for cryptographic suite management to assist skilled readers in understanding the following detailed description.

### DESCRIPTION OF THE DRAWINGS

A greater understanding of the embodiments will be had with reference to the Figures, in which:

FIG. 1 illustrates an example of wireless carrier assignment at a system AP;

FIG. 2 illustrates a system AP layout at a specific geographical area;

FIG. 3 illustrates an example of wireless carrier assignment at three system APs with overlapping coverage;

FIG. 4 illustrates an exemplary block diagram of a cellular communication system; and

FIG. 5 illustrates a multi-mode transceiver module connecting an AP controller.

### DETAILED DESCRIPTION

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It will be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following obviates or mitigates some or all of the issues introduced by fixed carrier assignment at system APs of a radio access network (RAN) with overlapping coverage, dynamic carrier assignment and dynamic carrier access using continuous spectrum sensing, independent operation of employed RATs in multi-RAT cellular communication RAN and independent operation of cellular communication systems deployed by independent mobile network operators. In suitable implementations, the following may enable full spectrum utilization at all geographical areas covered by cellular communication systems.

The following provides systems and methods for wireless dynamic spectrum access in cellular communication networks. In one aspect, a method which will be referred to herein as System-Aided Dynamic Carrier Access (SADCA) is provided. In SADCA, synchronized system Access Points (APs) broadcast the Carrier Activity Information (CAI), specifying actively utilized carriers, with the general system information. While the general system information is continuously broadcasted to enable User Equipment (UE) to connect to system APs, system APs with overlapping coverage can also tune in to the general system information broadcast of interfering APs. Broadcasting the CAI thus enables system APs with overlapping coverage to continuously determine and access inactive/unutilized carriers without requiring continuous spectrum sensing by system APs or continuous information exchange between system APs with overlapping coverage.

In another aspect, synchronized system APs are equipped with multi-mode transceiver modules, capable of demodulating and detecting wireless transmission of all employed RATs, to enable the detection of the CAI of all employed Radio Access Technologies (RATs) in multi-RAT systems. System APs with overlapping coverage then determine and access inactive/unutilized carriers of all employed RATs in multi-RAT systems without requiring continuous spectrum sensing by system APs, continuous information exchange between system APs with overlapping coverage or information exchange between independently operated RATs.

In yet another aspect, synchronized system APs tune in to the CAI broadcast of APs deployed by other mobile network operators to determine and access carriers inactive/unutilized by APs deployed by other mobile network operators without requiring continuous spectrum sensing by system APs, continuous information exchange between system APs deployed by different mobile network operators or information exchange between independently operated systems.

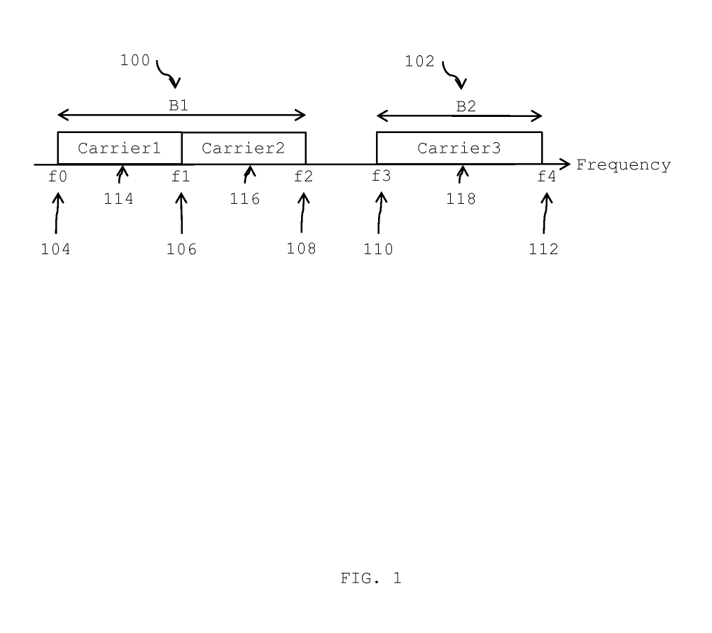

Referring now to FIG. 1, an example of carrier assignment in the frequency domain at a system AP employing a single RAT is provided. The system AP utilizes two non-contiguous frequency bands, B1 (100) and B2 (102). Band B1 ranges from frequency f0 (104) to frequency f2 (108) while band B2 ranges from frequency f3 (110) to frequency f4 (112). Two carriers utilizing equal transmission bandwidths are deployed over band B1 (100), Carrier1 (114) and Carrier2 (116). Carrier1 occupies the frequencies ranging from f0 (104) to f1 (106) while Carrier2 occupies the frequencies ranging from f1 (106) to f2 (108). On the other hand, a single carrier, Carrier3 (118), occupying the frequencies ranging from f3 (110) to f4 (112) and having a larger transmission bandwidth than carriers Carrier1 (114) and Carrier2 (116) is deployed over band B2 (102). The example of FIG. 1 clearly illustrates how carrier assignment at any system AP can be contiguous or non-contiguous and that carriers of any employed RAT can have non-equal transmission bandwidths. It should be understood that the example provided by FIG. 1 is for illustrative purposes only and that other configurations are contemplated.

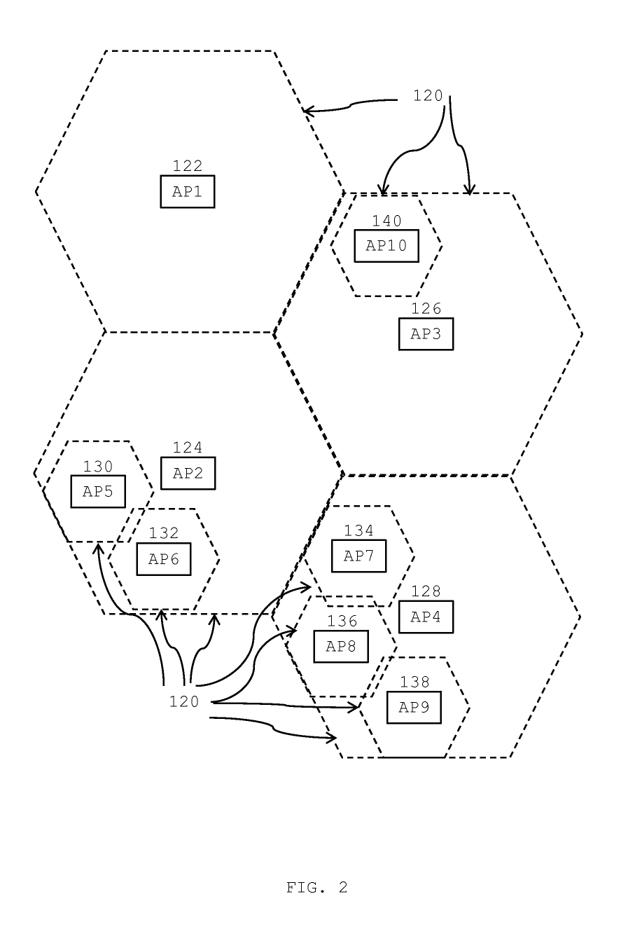

The choice of carrier bandwidths and deployment configuration at any system AP is dependent on the amount of spectrum available for the mobile network operator deploying the cellular communication system and the interference levels at system APs. FIG. 2 illustrates a top view layout of a system AP deployment comprising nine APs deployed at different locations to provide the required coverage and capacity at a specific geographical area. Coverage area of APs is referred to as cells (120) and is determined by the AP transmission power and radio propagation conditions. The coverage area of an AP utilizing a particular set of radio frequency resources, i.e. a particular set of carriers, specifies the area in which an AP causes significant levels of interference that prevents the reuse of the same set of radio frequency resources by any other AP in that area. In the example of FIG. 2, APs AP3 (126) and AP10 (140) have overlapping coverage and thus must utilize different sets of radio frequency resources at any time. Similarly, APs AP2 (124), AP5 (130) and AP6 (132) also have overlapping coverage and thus must also avoid the simultaneous utilization of the same set of radio frequency resources at any time. On the other hand, APs AP7 (134) and AP9 (138) do not have overlapping coverage and can thus utilize the same set of radio frequency resources at any time. However, the coverage of both APs AP7 (134) and AP9 (138) overlaps with the coverage of AP4 (128) and AP8 (136). Therefore, APs AP7 (134) and AP9 (138) must both avoid utilizing the sets of radio frequency resources utilized by APs AP4 (128) and AP8 (136) at any time. Conversely, the coverage of AP AP1 (122) does not overlap with the coverage of any other system AP in the example of FIG. 2. All available system radio frequency resources can thus be utilized at AP1 (122) at any time. It should be understood that the provided AP deployment layout in FIG. 2 is for illustrative purposes only and that other deployment layouts are contemplated.

Interference mitigation between system APs with overlapping coverage is primarily achieved by assigning different radio frequency resources, i.e. different carriers, to APs with overlapping coverage for all employed RATs. Carrier assignment at system APs with overlapping coverage is typically fixed in spite of the varying and fluctuating nature of user traffic demand, leading to suboptimal spectrum utilization in cellular communication systems with high AP density; since carriers assigned to certain APs may be unutilized at certain times under fixed carrier assignment. To maintain tangible spectrum utilization at all system APs, cellular systems deploying APs with overlapping coverage exploit traffic variations and fluctuations between system APs by employing dynamic carrier assignment and dynamic carrier access using spectrum sensing. In principle, both techniques take advantage of varying traffic demand between system APs to maximize spectrum utilization.

Under dynamic carrier assignment configurations, interfering system APs exchange traffic demand information to enable APs with high traffic demand to access unutilized carriers assigned to other APs. However, a fundamental shortcoming of this approach is that the amount of information exchange between interfering system APs increases with the number of interfering APs. Dynamic carrier assignment is thus restrained by large scale system AP densification; as a significant amount of system resources would be depleted by information exchange between interfering APs rather than being utilized for carrying user traffic.

An alternative approach to dynamic carrier assignment, that avoids requiring information exchange between system APs, is dynamic carrier access using spectrum sensing. Under dynamic carrier access using spectrum sensing, system APs with overlapping coverage continuously sense radio activity within the system radio frequency bands and opportunistically access carriers unutilized by other system APs. However, such an approach requires accurate spectrum sensing capabilities over wide frequency bands to ensure reliable system operation. Such sensing capabilities are difficult to provide at all system APs, thus limiting the feasibility of dynamic carrier access using spectrum sensing in cellular communication systems.

SADCA circumvents the shortcomings of both dynamic carrier access using spectrum sensing and dynamic carrier assignment to achieve full spectrum utilization at synchronized system APs with overlapping coverage. Means for achieving system AP synchronization include, but are not limited to, the employment of high accuracy oscillator circuits, Global Positioning System (GPS) or the IEEE 1588 protocol. Under SADCA, all system APs broadcast the Carrier Activity Information (CAI) with the general system information broadcast, such that the general system information broadcast of any system AP specifies actively utilized carriers within the set of carriers assigned to the system AP under fixed carrier assignment along with an indicator specifying need for additional spectrum access. System APs can access carriers assigned to other system APs with overlapping coverage only when such carriers are inactive/unutilized by the APs originally assigned to under fixed carrier assignment. To ensure reliable system operation, access of system APs to available carriers is fixed for a predefined period, chosen based on the system traffic fluctuation rate and referred to as the carrier access period. The CAI is updated at the beginning of each carrier access period. System APs with overlapping coverage tune in to the CAI broadcast of interfering APs at the beginning of each carrier access period to determine and access unutilized carriers. System APs with overlapping coverage define multiple carrier access configurations, in frequency and time, corresponding to different carrier activity scenarios and implement the adequate carrier access configuration based on the information obtained from the CAI broadcast of interfering APs.

The set of APs interfering with any system AP can be determined by a network element/data base communicatively coupled to all system APs or can be pre-programmed into system APs upon deployment. Alternatively, autonomous self-configuring system APs can determine the set of interfering APs by measuring the power levels of the general system information broadcast of other system APs. Similarly, possible carrier access configurations under different carrier activity scenarios can be determined by a network element/data base communicatively coupled to all system APs or can pre-programmed into system APs upon deployment while autonomous self-configuring APs can determine carrier access configurations under different carrier activity scenarios through information exchange between system APs with overlapping coverage during the initial setup phase when powered on for the first time.

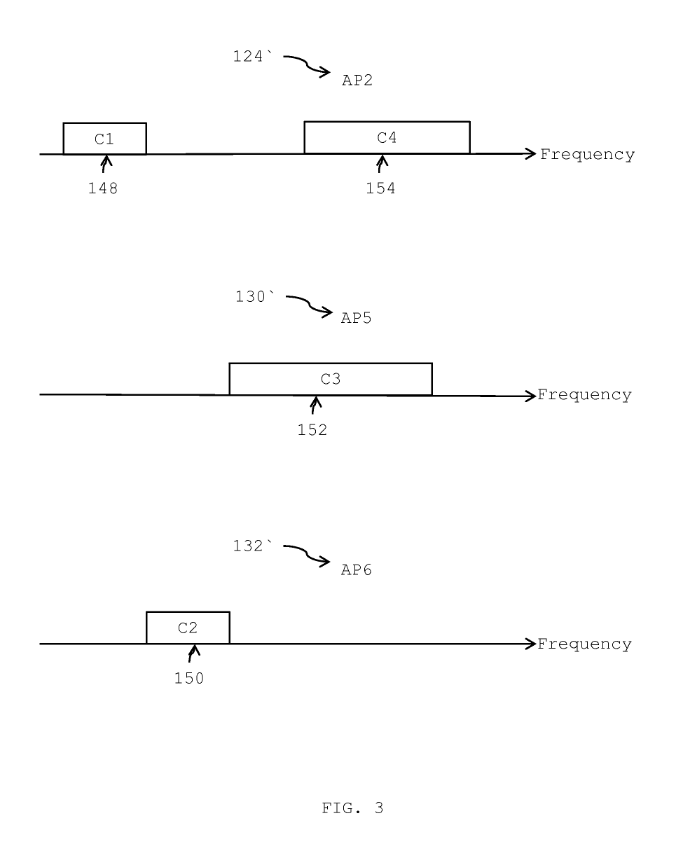

Referring now to FIG. 3, which illustrates the fixed carrier assignment for three system APs with overlapping coverage, AP2 (124′), AP5 (130′) and AP6 (132′). AP2 (124′) is assigned carriers C1 (148) and C4 (154) while AP5 (130′) is assigned carrier C3 (152) and AP6 (132′) is assigned carrier C2 (150). The possible carrier activity/utilization scenarios at any carrier access period for AP2 (124′) are as follows: no carriers active/utilized, only C1 (148) active/utilized, only C4 (154) active/utilized, both C1 (148) and C4 (154) are active/utilized. When both C1 (148) and C4 (154) are active/utilized, AP5 (130′) and AP6 (132′) refrain from accessing C1 (148) and C4 (154) under SADCA. When carrier C1 (148) is active/utilized and C4 (154) is inactive/unutilized by AP2 (124′), APs AP5 (130′) and AP6 (132′) can utilize C4 (154) under SADCA. AP5 (130′) can utilize C4 (154), when C4 (154) is inactive/unutilized by AP2 (124′), if AP6 (132′) does not indicate need for additional spectrum access and vice versa. If both AP5 (130′) and AP6 (132′) indicate need for additional spectrum access, APs AP5 (130′) and AP6 (132′) alternate in accessing C4 (154) when C4 (154) is inactive/unutilized by AP2 (124′), such that AP5 (130′) utilizes C4 (154) in the first carrier access period in which C4 (154) is inactive/unutilized by AP2 (124′) while AP6 (132′) utilizes C4 (154) in the following carrier access period in which C4 (154) is inactive/unutilized by AP2 (124′) and so on. Access of AP5 (130′) and AP6 (132′) to C1 (148) when 01 (148) is inactive/unutilized by AP2 (124′) under SADCA is performed in a similar matter to access of AP5 (130′) and AP6 (132′) to C4 (154) when C4 (154) is inactive/unutilized by AP2 (124′). Access of AP2 (124′) and AP6 (132′) to C3 (152) under SADCA, in addition to access of AP2 (124′) and AP5 (130′) to C2 (150) under SADCA, is also performed in a similar manner to the access of AP5 (130′) and AP6 (132′) to C1 (148) when C1 (148) is inactive/unutilized by AP2 (124′). It should be noted that priorities in accessing unutilized carriers between APs with overlapping coverage can be defined and that the provided example assumes equal priority in accessing unutilized carriers by all system APs. It should be understood that the example provided by FIG. 3 is for illustrative purposes only and that other configurations are contemplated.

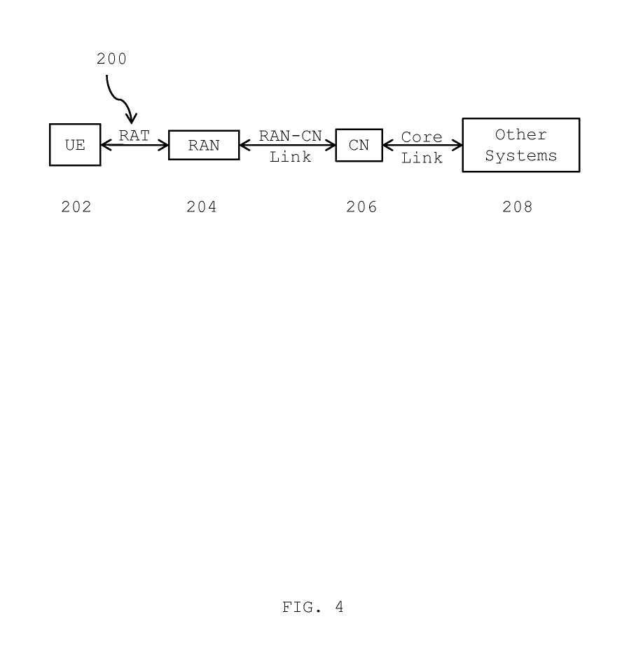

Referring now to FIG. 4, an exemplary network structure (200) for wireless cellular communication systems is shown. The network comprises a RAN (204) linked to a core network (CN) (206). The RAN, comprising system APs, is deployed to wirelessly connect UE (202) to the CN (206) using a single or plurality of RATs. The RAN (204) carries user traffic to the CN (206), where cellular systems are connected with other communication systems (208), and user traffic management at the CN (206) is independent of traffic originating system.

RANs would ideally utilize the most spectrally efficient RAT only. However, variations in the capabilities of UE entail the co-deployment of multiple RATs at system APs in cellular communication systems. System APs are typically capable of utilizing a single or plurality of RATs and cellular communication systems employing multiple RATs are referred to as multi-RAT systems. Multi-RAT systems apportion available radio frequency resources between co-deployed RATs and generally assign spectrum bands or sub-bands to each of the employed RATs based on the historical and/or projected traffic demand for each RAT; i.e. RATs with higher traffic demand would typically be assigned more spectrum, and vice versa. Spectrum partitioning between co-deployed RATs is typically fixed and applied at the system level, i.e. all system APs have the same spectrum partitioning between co-deployed RATs and employed RATs are independently operated in multi-RAT systems. Employed RATs can be assigned contiguous or non-contiguous spectrum bands and carrier assignment at system APs for any employed RAT can also be contiguous or non-contiguous within the spectrum bands assigned to such a RAT.

The independent operation of co-deployed RATs further reduces spectrum utilization in multi-RAT systems with dense AP deployment; since different RATs also experience varying and fluctuating traffic demand at different system APs. A similar inefficiency in overall spectrum utilization at any geographical area is attributed to the independent operation of cellular communication systems deployed by different mobile network operators; since APs deployed by different mobile network operators are also subject to varying and fluctuating traffic demand.

SADCA is extended to multi-RAT systems by equipping system APs with multi-mode transceiver modules that are capable of demodulating and detecting wireless transmission of all employed RATs to enable the detection of the CAI of all employed Radio Access Technologies (RATs) in multi-RAT systems. System APs utilizing any RAT can thus apply SADCA to determine and access unutilized carriers assigned other RATs at other system APs. Priority in accessing unutilized carriers assigned to any RAT is given to APs utilizing the same RAT over APs utilizing different RATs. System APs employing any RAT tune in to the CAI of APs employing other RATs and can access carriers assigned to APs employing other RATs only when such carriers are inactive/unutilized by the APs originally assigned to. To ensure reliable operation of all APs, access of system APs to available carriers is fixed for the duration of the carrier access period and the CAI is updated at the beginning of each carrier access period. APs with overlapping coverage tune in to the CAI broadcast of interfering APs at the beginning of each carrier access period to determine and access inactive/unutilized carriers assigned to any of the employed RATs. APs employing different RATs with overlapping coverage define multiple carrier access configurations, in frequency and time, corresponding to different carrier activity scenarios and implement the adequate carrier access configuration based on the information obtained from the CAI broadcast of interfering APs.

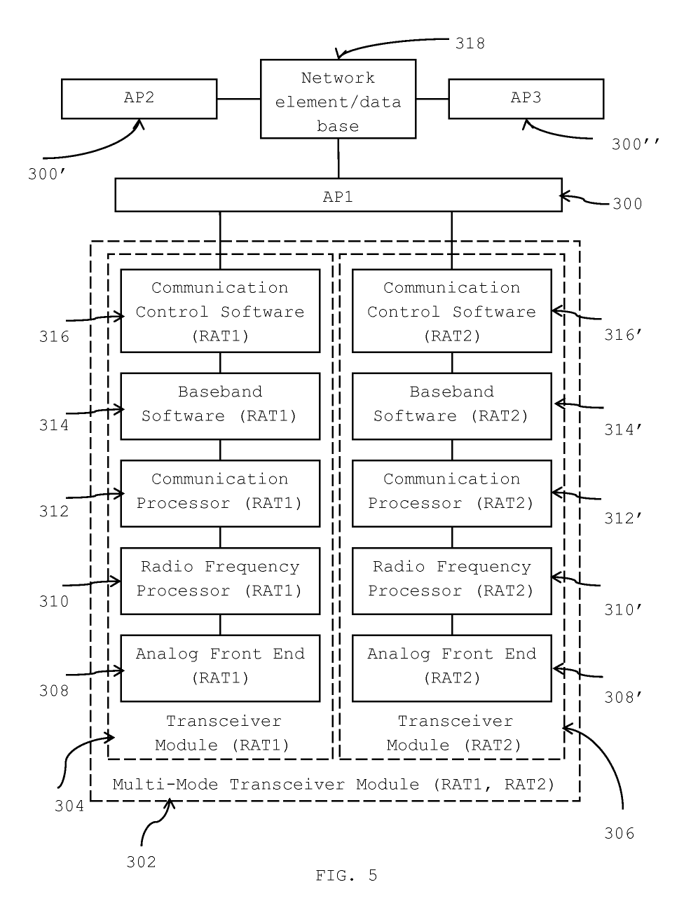

Referring now to FIG. 5, an example of a multi-mode transceiver module (302) communicatively coupled to an AP (300) is shown. The multi-mode transceiver module (302) illustrated in the example of FIG. 5, comprising transceiver modules for two RATs (304), (306), is capable of demodulating and detecting transmissions of the two RATs. The transceiver module of each RAT comprises communication control software (316), (316′) baseband software (314), (314′), communication processor (312), (312′), radio frequency processor (310), (310′) and analog front end (308), (308′). It should be understood that the setup, structure and configuration provided by the example of FIG. 3 is for illustrative purposes only and that other architectures, implementations, structures and configurations are contemplated.

The set of APs interfering with any system AP in multi-RAT systems can be determined by a network element/data base (318) communicatively coupled to all system APs (300, 300′, 300″, etc.) or can be pre-programmed into system APs upon deployment. Alternatively, autonomous self-configuring system APs can determine the set of interfering APs by measuring the power levels of the general system information broadcast of other system APs. Similarly, possible carrier access configurations under different carrier activity scenarios can be determined by a network element/data base communicatively coupled to all system APs or can pre-programmed into system APs upon deployment while autonomous self-configuring APs can determine carrier access configurations under different carrier activity scenarios through information exchange between system APs with overlapping coverage during the initial setup phase when powered on for the first time.

SADCA can also be extended to allow system APs deployed by any mobile network operator to determine and access inactive/unutilized carriers at APs deployed by other mobile network operators. Priority in accessing unutilized carriers at APs deployed by any mobile network is given to APs deployed by the same mobile network operator over APs deployed by other mobile network operators. System APs tune in to the CAI of APs deployed by other mobile network operators and can access carriers assigned to APs deployed by other mobile network operators only when such carriers are inactive/unutilized by the APs originally assigned to. To ensure reliable operation of all APs, access of system APs to available carriers is fixed for the duration of the carrier access period and the CAI is updated at the beginning of each carrier access period. APs with overlapping coverage tune in to the CAI broadcast of interfering APs at the beginning of each carrier access period to determine and access inactive/unutilized carriers. APs of different operators with overlapping coverage define multiple carrier access configurations, in frequency and time, corresponding to different carrier activity scenarios and implement the adequate carrier access configuration based on the information obtained from the CAI broadcast of interfering APs.

The set of APs interfering with any AP deployed by any mobile network operator can be determined by a network element/data base communicatively coupled to all APs deployed by all mobile network operators or can be pre-programmed into system APs upon deployment. Alternatively, autonomous self-configuring system APs can determine the set of interfering APs by measuring the power levels of the general system information broadcast of other system APs. Similarly, possible carrier access configurations under different carrier activity scenarios can be determined by a network element/data base communicatively coupled to all APs by all mobile network operators or can pre-programmed into system APs upon deployment while autonomous self-configuring APs can determine carrier access configurations under different carrier activity scenarios through information exchange between system APs with overlapping coverage during the initial setup phase when powered on for the first time.

Although the foregoing has been described with reference to certain specific embodiments, various modifications thereto will be apparent to those skilled in the art without departing from the spirit and scope of the invention as outlined in the appended claims. The entire disclosures of all references recited above are incorporated herein by reference.

1. A method for dynamic assignment of wireless cellular carrier spectrum, the method comprising:
a. establishing a radio access network comprising the deployment of a plurality of access points having an overlapping service area, each access point being configurable to utilize a dynamically allocated spectrum; and
b. configuring each of the access points to:
i. broadcast, indirectly to any of the other access points, carrier activity information, the carrier activity information comprising an indication of utilization of carrier spectrum by the respective access point;
ii. monitor spectrum utilization for each other access point in the area;
iii. determine, for each of the other access points, whether any of the other access points are assigned unutilized spectrum;
iv. request from the other access point access to one or more unutilized spectrum; and
v. access any of the one or more unutilized spectrum.

2. The method of claim 1, wherein the broadcast of carrier activity information is made with a general system information broadcast.

3. The method of claim 1, wherein the monitoring, determining and requesting is made at a predefined period.

4. The method of claim 3, wherein the predefined period is a carrier access period.

5. The method of claim 1, wherein the configuring each of the access points is pre-set upon radio access network deployment.

6. The method of claim 1, wherein the configuring each of the access points is determined using information exchange between self-configuring system access points.

7. The method of claim 1, wherein the configuring each of the access points is determined by a network element communicatively coupled to all system access points.

8. The method of claim 1, wherein the radio access network utilizes multiple radio access technologies (RATs) and access points comprise multi-mode transceiver modules capable of demodulating and detecting wireless transmission of all employed RATs.

9. The method of claim 8, wherein each access point utilizing a specific RAT accesses unutilized wireless carriers assigned to other RATs at other access points.

10. The method of claim 1, wherein the access points tune in to the carrier activity information broadcast of access points deployed by other mobile network operators.

11. The method of claim 10, wherein access points deployed by a specific mobile network operator access unutilized carrier spectrum assigned to access points deployed by other mobile network operators.

12. A system for dynamic assignment of wireless cellular carrier spectrum in a radio access network, the system comprising a plurality of access points deployable in a configuration such that at least two of the access points have an overlapping service area, each access point comprising one or more processors and a data storage device in communication with the one or more processors, the one or more processors configurable to execute utilization of a dynamically allocated spectrum by:
a. broadcasting, indirectly to any of the other access points, carrier activity information, the carrier activity information comprising an indication of utilization of carrier spectrum by the respective access point;
b. monitoring spectrum utilization for each other access point in the area;
c. determining, for each of the other access points, whether any of the other access points are assigned unutilized spectrum;
d. requesting from the other access point access to one or more unutilized spectrum; and
e. accessing any of the one or more unutilized spectrum.

13. The system of claim 12, wherein each access point broadcasts carrier activity information with a general system information broadcast.

14. The system of claim 12, wherein the monitoring, determining and requesting is made at a predefined period.

15. The system of claim 14, wherein the predefined period is a carrier access period.

16. The system of claim 12, wherein each of the access points is pre-configured to access spectrum upon radio access network deployment.

17. The system of claim 12, wherein each of the access points is self-configuring and exchanges information with at least a subset of the other access points to configure access to spectrum.

18. The system of claim 12, wherein a network element communicatively coupled to each access point configures the access to spectrum.

19. The system of claim 12, wherein the radio access network utilizes multiple radio access technologies (RATs) and access points comprise multi-mode transceiver modules capable of demodulating and detecting wireless transmission of all employed RATs.

20. The system of claim 19, wherein each access point utilizing a specific RAT accesses unutilized wireless carriers assigned to other RATs at other access points.

21. The system of claim 12, wherein the access points tune in to the carrier activity information broadcast of access points deployed by other mobile network operators.

22. The system of claim 21, wherein access points deployed by a specific mobile network operator access unutilized carrier spectrum assigned to access points deployed by other mobile network operators.
